(19) United States
(12) Patent Application Publication
(10) Pub. No.: US 2012/0305713 A1
(43) Pub. Date: Dec. 6, 2012

(54) RAM AIR PARACHUTE VARIABLE TRIM PLATFORM

(75) Inventors: Frank Deazley, Kissimmee, FL (US); Scott Hilton, Kissimmee, FL (US)

(73) Assignee: Aerial Delivery Solutions, LLC, Kissimmee, FL (US)

(21) Appl. No.: 13/429,939

(22) Filed: May 17, 2012

Related U.S. Application Data
(60) Provisional application No. 61/492,945, filed on Jun. 3, 2011.

(51) Int. Cl. B64D 17/34

(52) U.S. Cl. 244/152

(57) ABSTRACT

A method of controlling a ram air parachute using a variable trim platform is disclosed. In a particular embodiment, the method includes securing a front trim control line between a front portion of the variable trim platform and a guidance control unit and securing a rear trim control line between a rear portion of the variable trim platform and the guidance control unit. The method also includes securing ram air parachute suspension lines between the variable trim platform and the parachute and securing guidance unit risers between the variable trim platform and the guidance unit. An attachment point of the guidance unit risers to the variable trim platform is separate from an attachment point of the suspension lines to the platform to create a pivot point for the variable trim platform to rotate about.

### I. CROSS REFERENCE TO RELATED APPLICATIONS

This application claims the benefit of U.S. Provisional Application No. 61/492,945 filed Jun. 3, 2011. The disclosure of the provisional application is incorporated herein by reference.

### II. FIELD

The present disclosure is generally related to a ram air parachute variable trim platform.

### III. DESCRIPTION OF RELATED ART

A parafoil is an airfoil with an aerodynamic cell structure that is inflated. Ram air inflation forces the parafoil into a classic wing cross-section. Most ram air parachutes have their leading edges open to allow for inflation as they move through air. Ram air parachutes are designed with individually inflatable cells to help maintain structural rigidity and to add stability during flight. Suspension lines are rigged to give the canopy an anhedral shape. Maneuvering is then achieved by deflecting the outer trailing edges of the canopy. For example, symmetric deflections are used for flaring and velocity control. A ram-air parachute's structure is very light, which means that it is heavily influenced by the air passing over and around it.

Ram air parachutes have already proven to be useful in many situations as a delivery vehicle for cargo and other payloads. Their stable configuration suits autonomous guidance systems, and a low descent rate makes them an attractive choice to safely deliver payloads to the ground. Maneuvering is normally achieved by deflecting the trailing edges of the canopy asymmetrically, while some degree of glide slope control is offered with symmetric flap deflections. Dropped from a sufficient altitude, a ram air parachute is capable of reaching a much larger area than the ballistic payload delivery vehicle (PDV).

These attributes of the ram air parachute offer a great deal of flexibility to the precision delivery of a payload. The payload can be dropped further away from the target, which may be desirable for missions over hostile areas. In addition, the longer flight duration allows for the landing zone to be surveyed during descent. One of the main advantages of the ram air parachute method of delivery is the longer flight time and it could potentially be deployed miles away from the target. However, the slow descent complicates other aspects of the delivery. Adjustments must be made to the glide path to target, and a trajectory must be planned in advance.

Knowledge of wind speed and direction is required before a successful trajectory can be accomplished. It is also very important that accurate estimates of the launch position is known throughout the trajectory. Winds can shift, or the ram air parachute may perform somewhat differently than what was initially assumed. Adjustments to the trajectory are needed to ensure finding the final approach point.

An important component of computing an intended trajectory is its ability to compensate to changing conditions in real-time. As the ram air parachute delivery system descends toward the ground, adjustments in its course may be necessary. The parachute may have trouble following its planned trajectory, and if such deviations can be detected, it is helpful to modify the trajectory to give the best possible chance of reaching the target. There are a variety of situations that may cause the parachute to drift off its intended path such as errors in the assumptions made in the computation of the intended trajectory. In addition, conditions may change mid-flight as wind speed and direction can vary with both time and altitude.

Accordingly, what is needed in the art is an improved aerial delivery system with the ability to adjust its flight path angle in flight to reach the intended target.

### IV. SUMMARY

In a particular embodiment, a ram air parachute with variable trim platform is disclosed. The platform includes a leading structural member, a trailing structural member, two outer side members secured between the leading structural member and the trailing structural member, and two or more inner struts spanning between the leading structural member and the trailing structural member. The leading structural member also includes a front control line attachment(s), where the front control line attachment is adapted to secure a front control line to a guidance unit. Similarly, the trailing structural member includes a rear control line attachment(s), where the rear control line attachment is adapted to secure a rear control line to the guidance unit. The outer side members and inner struts each further include a plurality of parachute suspension line attachments, where the parachute suspension lines attachments are disposed from a leading edge to a trailing edge of a parachute. The inner struts and outer side members each include at least one guidance unit riser attachment, where each of the guidance unit riser attachments provide a point of attachment for a respective guidance unit riser that forms a lateral pivot point about which the platform can tilt forward and backward relative to a forward direction of the parachute. A guidance unit is secured to the platform using the respective guidance unit risers, where the guidance unit is adapted to retract and pay out a desired amount of the front control line and the rear control line to cause the platform to tilt forward and backward about the lateral pivot point.

In another particular embodiment, a method of controlling a ram air parachute using a variable trim platform is disclosed. The method includes securing a front trim control line between a front portion of the variable trim platform and a guidance control unit, and securing a rear trim control line between a rear portion of the variable trim platform and the guidance control unit. In addition, the method includes securing ram air parachute suspension lines between the variable trim platform and the parachute, and securing guidance unit risers between the variable trim platform and the guidance unit. An attachment point of the guidance unit risers to the variable trim platform is separate from an attachment point of the suspension lines to the platform to create a pivot point for the variable trim platform to rotate about. The front portion of the variable trim platform may be pulled down using the front trim control line to change an angle of incidence of the parachute to increase a speed and rate of descent and, similarly, the rear portion of the variable trim platform may be pulled down using the rear trim control line to change the angle of incidence of the parachute to decrease the speed of the parachute and rate of descent. Further, the method includes setting a pre-determined angle of incidence of the platform before the parachute is deployed and securing a payload to suspend from the guidance unit. The location of the pivot point may be adjusted forward or rearward on the variable trim platform to set a desired angle of incidence of the parachute. The front and rear trim control lines are secured separately from the parachute suspension lines to structural members of the variable trim platform.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a bottom perspective view of a particular illustrative embodiment of a ram air parachute variable trim platform;

FIG. 2 is a top view of the particular illustrative embodiment of the variable trim platform;

FIG. 3 is a bottom view of the particular illustrative embodiment of the variable trim platform;

FIG. 4 is a elevational view of the particular illustrative embodiment of the variable trim platform;

FIG. 5 is a front view of the particular illustrative embodiment of the variable trim platform;

FIG. 6 is an elevational view of the variable trim platform secured to a parachute and a guidance unit;

FIG. 7 is an elevational view of the variable trim platform secured to the parachute and the guidance unit where a front portion of the variable trim platform has been pulled down about a pivot point to change an angle of incidence to increase speed and rate of descent; and

FIG. 8 is an elevational view of the variable trim platform secured to the parachute and the guidance unit where a rear portion of the variable trim platform has been pulled down about a pivot point to change an angle of incidence to decrease the speed and the rate of descent.

### VI. DETAILED DESCRIPTION

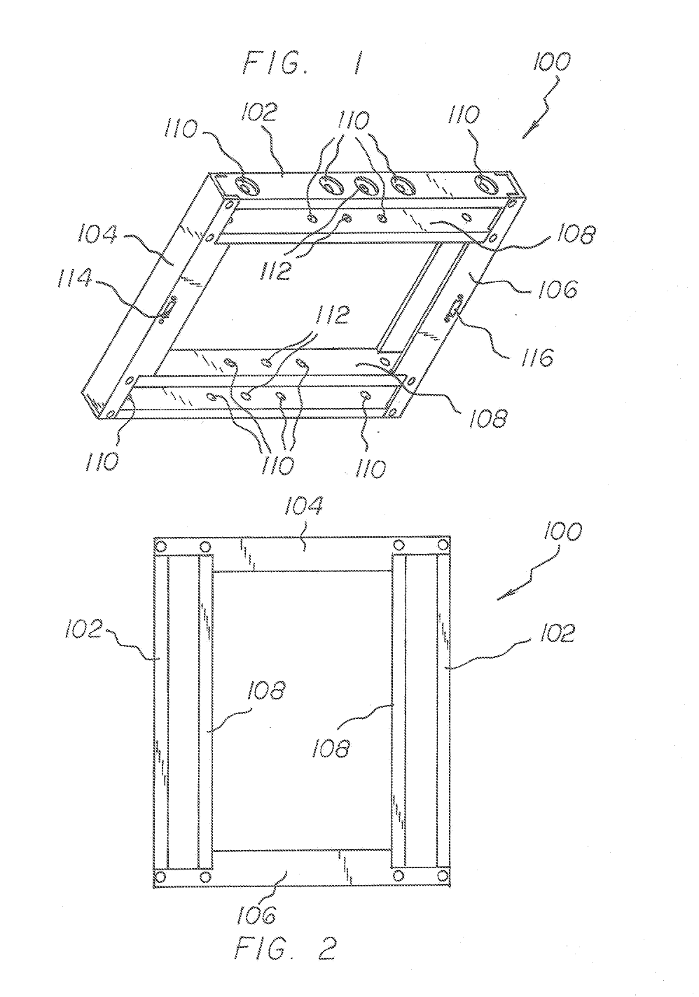

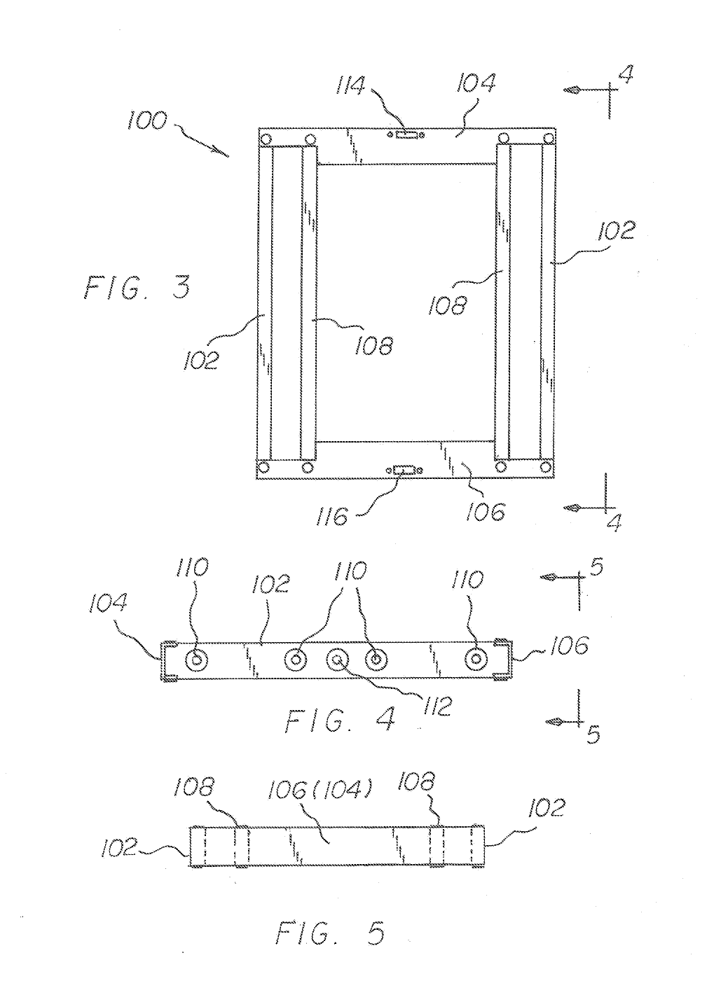

Referring to FIGS. 1-5, a particular illustrative embodiment of a ram air parachute variable trim platform (“VTP” or “platform”) is disclosed and generally designated 100. As explained below, the VTP 100 allows trim changes to parachutes, such as a ram air parachute, for example, by providing a pivot point at the riser attachment points 112 separate from suspension line attachment points 110. There are no prior art systems that suggest or describe a platform 100 to create the separation as described herein. The VTP 100 may be easily adapted and constructed to be used with any number of sizes and shapes of parachutes. In addition, the VTP 100 is fabricated of load bearing materials that are selected based on the particular deployment conditions.

The VTP 100 includes a front leading structural member 104 with an attachment point(s) 114, where the attachment point 114 is used to secure a front control line to the platform 100 to allow a guidance unit to pull down on the front of the VTP 100. A rear trailing structural member 106 includes a similar attachment point(s) 116 to secure a rear control line to the platform 100 to allow the guidance unit to pull down the rear of the VTP 100. Several structural members 102, 108 may be used (depending on load bearing requirements) to connect the front 104 of the VTP 100 to the rear 106 of the VTP 100. For example, two outer side members 102 may be secured between the leading structural member 104 and the trailing structural member 106. In addition, two inner struts 108 may be used to span between the leading structural member 104 and the trailing structural member 106.

There may be a minimum of two attachment points 112 (depending on load bearing requirements) for suspension of the guidance unit below the VTP 100. These attachment points 112 are aligned on the VTP 100 to create a pivot point for VTP 100 movement. This pivot point can be created at any point from the front of the VTP 100 to the back of the VTP 100 by providing attachment points 112 at the desired location and depending on design requirements. For example, one guidance riser can be secured to the first attachment point 112 on a first side, and a second guidance riser can be secured to the first attachment point 112 on an opposing side to laterally span the platform 100 from one side to the other (i.e., left to right).

Parachute suspension line attachment points 110 are disposed on the VTP 100 to allow the movement of the VTP 100 to change the incidence angle of the parachute. These attachment points 110 may also be designed to hold individual suspension lines or groups of suspension lines as dictated by the size and shape of the parachute. The angle of incidence can be thought of as the trim (nose up or nose down) of the parachute and is built into the parachute by the length of the suspension lines 126.

The VTP 100 may include load bearing mechanisms that are designed to hold the controlling lines of the parachute at a set dimension until moved by the parachute guidance unit. These mechanisms may be attached to the VTP 100 in a place specified by the size and shape of the parachute. For example, the front member 104, rear member 106 or any point along the structural members 102 and 108 from front to rear. These mechanisms are designed to the specifications dictated by the size and shape of the parachute.

Structural members that can withstand the applied forces are required. In addition, attachment points 112 for guidance unit risers are required. Attachment points 110 for suspension lines are required. Attachment points 114, 116 for trim control lines are required. The number of all attachment points can be increased or decreased as parachute size and shape dictates.

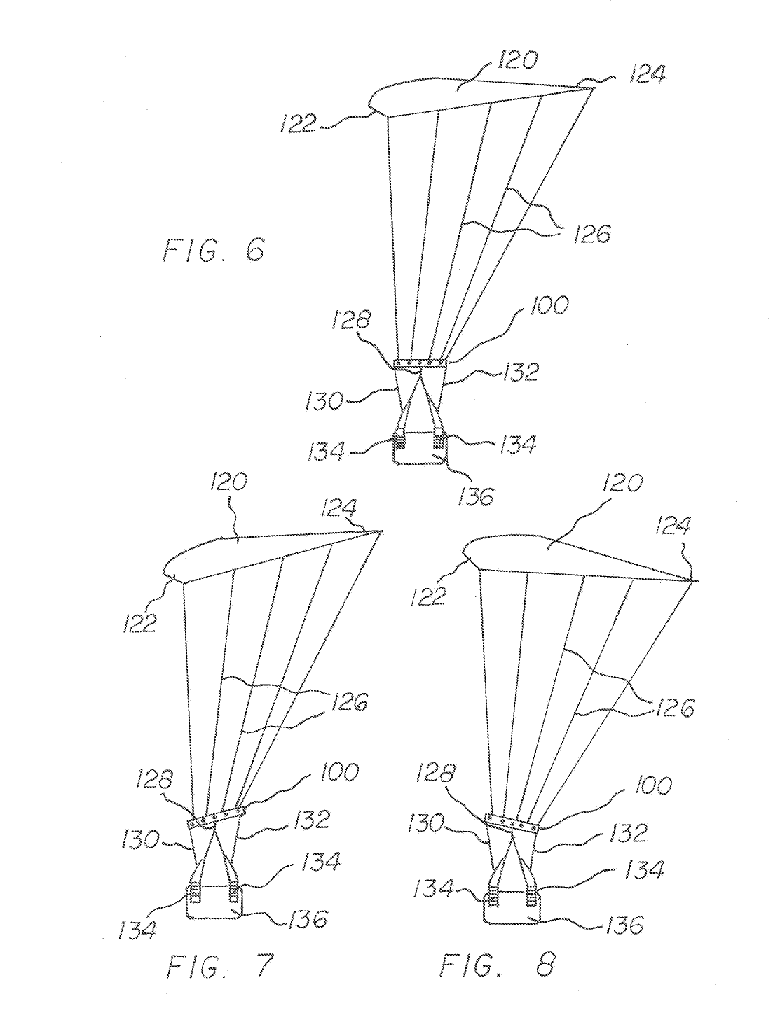

Referring now to FIGS. 6-8, the VTP 100 is integrated into a parachute system by being inserted between the suspension risers 134 of the guidance unit 136 and the suspension lines 126 of the parachute 120. This separates the suspension line groups from the front to back of the parachute 120 (cord wise direction). The suspension risers 134 from the guidance unit 136 are attached to the variable trim platform 100 with separation from the left to right of the parachute 120 (span wise direction) with a single point of attachment 128 on each side of the platform 100 to create a pivot point. A front trim control line 130 may be routed from a servo of the guidance unit 136 and attached to the front member 104 of the VTP 100 that allows the front of the platform 100 to be pulled down. A rear trim control line 132 may be routed from a servo of the guidance unit 136 and attached to the rear member 106 of the VTP 100 that allows the rear of the platform 100 to be pulled down. Both of these control lines 130, 132 work in unison to pull down the front of the platform 100 while letting the back go up or pulling down the back while letting the front of the platform 100 go up.

The VTP 100 provides at least two valuable functions. One function is that the VTP 100 holds the forces applied by the parachute 120 throughout the deployment and flight sequence while maintaining a set angle of incidence. This is accomplished in part by the parachute suspension lines 126 being attached to the VTP 100 in a way designated to hold the parachute 120 at the desired incidence angle. The VTP is attached to the guidance unit 136 using the suspension risers 134 in such a way as to allow the platform 100 to pivot about the lateral pivot point 128 while holding the required load. The trim control risers 130, 132 are routed from the guidance unit 136 to the VTP 100 so that they hold the platform 100 at the desired incidence angle. The two inner struts 108 may include guidance unit riser attachments 112, where each of the guidance unit riser attachments 112 provides a point of attachment for a respective guidance unit riser 134 that forms the lateral pivot point 128 about which the platform 100 can tilt forward and backward relative to a forward direction of the parachute 120. The guidance unit 136 is adapted to retract and pay out a desired amount of the front control line 130 and the rear control line 132 to cause the platform to tilt forward and backward about the lateral pivot point 128. The lateral pivot point 128 is formed between two aligned guidance riser attachment points 112 disposed on each of the inner struts 112, for example.

The second function is to enable the guidance unit 136 to change the angle of incidence. This is accomplished by the movement of the trim control risers 130, 132 that are pulled by the guidance unit 136 to change the angle of the VTP 100 which then changes the incidence angle of the parachute 120. The angle of incidence can be altered by using either front 130 or rear riser 132 input. Pulling down the front riser 130 changes the angle of incidence. At the steeper angle, the parachute 120 will descend faster but the apparent wind striking the parachute 120 remains fairly constant, although it will shift momentarily as the maneuver begins and ends. Flatter trim will let the parachute 120 fly further, but the penalty is that the parachute 120 may not be pressurized as well as a more steeply trimmed parachute 120, resulting in more vulnerability to turbulence. Steeper trim increases descent rate and pressurization but sacrifices glide.

In a particular illustrative embodiment, the VTP 100 may be constructed of any load bearing material and is designed to meet the requirements dictated by the size and shape of the parachute 120. It could be made as a solid piece or several pieces that are bolted together. The suspension components for the guidance unit 136 and parachute 120 would be attached using bolts, clips or knotted materials to the main body of the platform 100. The incidence angle components would be attached using bolts, clips or knotted materials to the front and rear of the platform. In addition, more than one VTP 100 may be used in a particular alternative configuration.

In operation, a parachute system with the VTP 100 attached exits an aircraft with the parachute 120 deployed. The VTP 100 is set at an incidence angle that allows the parachute 120 to deploy safely. Once the parachute 120 is flying and able to maneuver, the angle of the VTP 100 may be changed (automatically or remotely) by the guidance unit 136 of the system, which in turn changes the incidence angle of the parachute wing 120. By pulling the front of the platform 100 down, the front 122 of the parachute 120 is also pulled down while the rear 124 of the parachute 120 is let up, thereby changing the incidence angle of the parachute wing 120. This increases the speed and rate of descent of the parachute 120. By pulling the rear of the platform 100 down, the rear 124 of the parachute 120 is also pulled down while the front 122 of the parachute 120 is let up, thereby changing the incidence angle of the parachute wing 120. This decreases the speed and rate of descent of the parachute 120. These maneuvers can be done as many times as required by the system during flight to land it in the designated landing area.

Prior art flapping or spooling servos may be used to adjust the ram air parachute trajectory. Spooling servos allow an unlimited deflection range, and because the control lines 130, 132 simply wind around a central spool, there is less risk in damaging the servo during the parachute opening. Flapping servos are likely to be faster and are simpler to employ, yet may require a larger space within the system. With a pair of spooling servos, the servos wind the front control line 130 and rear control line 132 around a respective spool, where the front 130 and rear 132 control lines work in unison to either decrease the length of the front control line 130 to pull down the leading structural member 104 while paying out a corresponding length of the rear control line 132. Likewise, the servos may decrease the length of the rear control line 132 to pull down on the trailing structural member 106 while paying out a corresponding length of the front control line 130.

In a particular illustrative embodiment of the method of controlling a ram air parachute using a variable trim platform, the method includes securing a front trim control line between a front portion of the variable trim platform and a guidance control unit, securing a rear trim control line between a rear portion of the variable trim platform and the guidance control unit, securing ram air parachute suspension lines between the variable trim platform and the parachute, and securing guidance unit risers between the variable trim platform and the guidance unit. An attachment point of the guidance unit risers to the variable trim platform is separate from an attachment point of the suspension lines to the platform to create a pivot point for the variable trim platform to rotate about. In addition, the method may include that the front portion of the variable trim platform is pulled down using the front trim control line to change an angle of incidence of the parachute to increase a speed and rate of descent and the rear portion of the variable trim platform is pulled down using the rear trim control line to change the angle of incidence of the parachute to decrease the speed of the parachute and rate of descent.

A pre-determined angle of incidence of the platform may be set before the parachute is deployed. A payload may be secured to the guidance unit and suspended from the structure of the guidance unit. The method also includes that the location of the pivot point may be adjusted forward or rearward on the variable trim platform using the attachment points 112 to set a desired angle of incidence of the parachute 120. Further, the front and rear trim control lines are secured separately from the parachute suspension lines to structural members of the variable trim platform.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A ram air parachute variable trim platform, the platform comprising:
a leading structural member;
a trailing structural member;
two or more outer side members secured between the leading structural member and the trailing structural member; and
two or more inner struts spanning between the leading structural member and the trailing structural member.

2. The platform of claim 1, the leading structural member further comprising a front control line attachment, wherein the front control line attachment is adapted to secure a front control line to a guidance unit.

3. The platform of claim 2, the trailing structural member further comprising a rear control line attachment, wherein the rear control line attachment is adapted to secure a rear control line to the guidance unit.

4. The platform of claim 3, the two outer side members each further comprising a plurality of parachute suspension line attachments, wherein the parachute suspension lines attachments separate parachute suspension lines from a leading edge to a trailing edge of a parachute.

5. The platform of claim 4, the two inner struts each further comprising at least one guidance unit riser attachment, wherein each of the guidance unit riser attachments provide a point of attachment for a respective guidance unit riser that forms a lateral pivot point about which the platform can tilt forward and backward relative to a forward direction of the parachute.

6. The platform of claim 5, further comprising a guidance unit secured to the platform using the respective guidance unit risers, wherein the guidance unit is adapted to retract and pay out a desired amount of the front control line and the rear control line to cause the platform to tilt forward and backward about the lateral pivot point.

7. The platform of claim 6, the guidance unit further comprising a pair of spooling servos to wind the front control line and rear control line each around a respective spool, wherein the front and rear control lines work in unison to either decrease the length of the front control line to pull down the leading structural member while paying out a corresponding length of the rear control line, or to decrease the length of the rear control line to pull down the trailing structural member while paying out a corresponding length of the front control line.

8. A method of controlling a ram air parachute using a variable trim platform, the method comprising:
securing a front trim control line between a front portion of the variable trim platform and a guidance control unit;
securing a rear trim control line between a rear portion of the variable trim platform and the guidance control unit;
securing ram air parachute suspension lines between the variable trim platform and the parachute; and
securing guidance unit risers between the variable trim platform and the guidance unit;
wherein an attachment point of the guidance unit risers to the variable trim platform is separate from an attachment point of the suspension lines to the platform to create a pivot point for the variable trim platform to rotate about.

9. The method of controlling the ram air parachute of claim 8, wherein the front portion of the variable trim platform is pulled down using the front trim control line to change an angle of incidence of the parachute to increase a speed and rate of descent.

10. The method of controlling the ram air parachute of claim 9, wherein the rear portion of the variable trim platform is pulled down using the rear trim control line to change the angle of incidence of the parachute to decrease the speed of the parachute and rate of descent.

11. The method of controlling the ram air parachute of claim 10, further comprising setting a pre-determined angle of incidence of the platform before the parachute is deployed.

12. The method of claim 11, further comprising securing a payload to the guidance unit.

13. The method of claim 12, further comprising adjusting the location of the pivot point forward or rearward on the variable trim platform to set a desired angle of incidence of the parachute.

14. The method of claim 13, further comprising constructing the variable trim platform of load bearing materials that are selected to withstand deployment forces of the parachute.

15. The method of claim 14, wherein the front and rear trim control lines are secured separately from the parachute suspension lines to structural members of the variable trim platform.

16. A ram air parachute variable trim platform, the platform comprising:
parachute suspension lines secured to the platform; and
guidance unit risers secured separately about a pivot point of the platform;
wherein the platform is adapted to rotate about the pivot point to change an angle of incidence of the parachute.

17. The platform of claim 16, further comprising a guidance unit adapted to rotate the platform using a front control line and a rear control line.

18. The platform of claim 17, wherein the guidance unit is adapted to retract and pay out a desired amount of the front control line and the rear control line to cause the platform to rotate forward and backward about the pivot point.

19. The platform of claim 18, wherein a payload is adapted to be suspended below the guidance unit.

20. The platform of claim 19, wherein a location of the pivot point is adapted to be moved forward or rearward on the variable trim platform to set a desired angle of incidence of the parachute.
